(19) United States
(12) Patent Application Publication
(10) Pub. No.: US 2014/0297632 A1
(43) Pub. Date: Oct. 2, 2014

(54) REALTIME SEARCH GRID UPDATES

(71) Applicants: Avinash Sridhar, Cranbury, NJ (US); David Anthony Campana, Kirkland, WA (US); David Brian Anderson, Hamilton, NJ (US)

(72) Inventors: Avinash Sridhar, Cranbury, NJ (US); David Anthony Campana, Kirkland, WA (US); David Brian Anderson, Hamilton, NJ (US)

(21) Appl. No.: 13/989,895

(22) PCT Filed: Oct. 20, 2011
(86) PCT No.: PCT/US11/57065

§ 371 Date: Mar. 14, 2014

Related U.S. Application Data
(60) Provisional application No. 61/425,795, filed on Dec. 22, 2010.

(51) Int. Cl. G06F 17/30

(52) U.S. Cl. CPC G06F 17/30554; G06F 17/3053
USPC 707/732

(57) ABSTRACT

A search engine performs searches on displayed information to facilitate in limiting the search results and increasing relevancy. The search engine allows user inputs to influence a search boundary and/or a search result. The search boundaries and/or search results can also be influenced by social networking information and the like. The search results can be dynamically filtered by the search engine as the user enters in their search criteria. The searched information is limited to what is visually seen by a user on a screen/display device. This significantly reduces the displayed results and lets the user instantly see what their search parameters will yield.

This application claims priority from U.S. Provisional Application No. 61/425,795 filed 22 Dec. 2010.

### BACKGROUND

Electronic program guides (EPGs) provide listings of all available channels for a given time. This can be a daunting list when consumers can have hundreds or even thousands of channel choices. Consumers can attempt to use conventional search means to find a program, but it is a very slow and cumbersome process. This is because a typical programming guide searches all programming guide data, returning a significant amount of search results with little relevancy to a user. The user is then forced to search again through the search results to find relevant programs—which is both time consuming and frustrating.

### SUMMARY

User searches of programming information are accomplished using a mined electronic program guide and then selectively displaying results as the user enters in their search criteria. The searched information is limited to what is visually seen by a user on a screen/display device. This significantly reduces the displayed results and lets the user instantly see what their search parameters will yield. The searching parameters can include title information and/or descriptive information and the like.

The above presents a simplified summary of the subject matter in order to provide a basic understanding of some aspects of subject matter embodiments. This summary is not an extensive overview of the subject matter. It is not intended to identify key/critical elements of the embodiments or to delineate the scope of the subject matter. Its sole purpose is to present some concepts of the subject matter in a simplified form as a prelude to the more detailed description that is presented later.

To the accomplishment of the foregoing and related ends, certain illustrative aspects of embodiments are described herein in connection with the following description and the annexed drawings. These aspects are indicative, however, of but a few of the various ways in which the principles of the subject matter can be employed, and the subject matter is intended to include all such aspects and their equivalents. Other advantages and novel features of the subject matter can become apparent from the following detailed description when considered in conjunction with the drawings.

### BRIEF DESCRIPTION OF THE DRAWINGS

FIG. 1 shows a screen device display illustrating an electronic programming guide.

FIG. 2 depicts the resulting screen device display after a search term is typed into a search box.

FIG. 3 is an example system that uses a search engine based on displayed information.

FIG. 4 is an example of a method of providing search results.

### DETAILED DESCRIPTION

The subject matter is now described with reference to the drawings, wherein like reference numerals are used to refer to like elements throughout. In the following description, for purposes of explanation, numerous specific details are set forth in order to provide a thorough understanding of the subject matter. It can be evident, however, that subject matter embodiments can be practiced without these specific details. In other instances, well-known structures and devices are shown in block diagram form in order to facilitate describing the embodiments.

As used in this application, the term “component” is intended to refer to hardware, software, or a combination of hardware and software in execution. For example, a component can be, but is not limited to being, a process running on a processor, a processor, an object, an executable, and/or a microchip and the like. By way of illustration, both an application running on a processor and the processor can be a component. One or more components can reside within a process and a component can be localized on one system and/or distributed between two or more systems. Functions of the various components shown in the figures can be provided through the use of dedicated hardware as well as hardware capable of executing software in association with appropriate software.

Although the following descriptions can refer to a system that utilizes a first screen and a second screen, the principles described can be utilized on single and/or multiple screen systems. The screen devices can include television sets, monitors, hand-held devices such as personal digital assistants (PDA), smart phones, wireless/wired pads, laptops, remotes, etc.

In one instance, a search of an enhanced electronic programming guide (EPG) is bounded by what is displayed to a user. This allows the user, who may have previously selected display parameters, search only what they are interested in viewing. The user is not distracted by the thousands of other search results that are not of interest. This technique can be utilized in multi-screen systems to assist a user in quickly finding viewing content. A second screen device is often very user specific, and these pre-established user boundaries for viewing can be leveraged to provide a much enhanced search result. By limiting the search to what a user is currently viewing, their personal settings are incorporated into the search results along with any additional settings if available.

In a similar instance, a search is performed only on what is currently being displayed to a user on a 2nd screen device which is associated with a 1st screen program that is being watched. This significantly limits the search results and also increases the relevancy of the search results. An autocompletion function can be implemented as well. The autocompletion function can be limited to the information currently being viewed by the user. This eliminates irrelevant autocompletion suggestions that are found in most autocomplete systems. In one example, the search is performed on titles, show summary information, actor/cast information, short and/or long descriptions provided by schedules directly and/or mined extended information about the show and the like. Any of this information can be used to autocomplete a search parameter. Social networking information can also be utilized so that friends and the like can also be autocompleted.

Filters can also be employed based on what friends are viewing, etc.

In one example, the information displayed to the user consists of a mined program guide associated with what is being viewed on a 1st screen. This allows a user to search for information related to the currently viewed program. The search results will have high relevancy to the user as the 2nd screen is displaying information that the user is already interested in viewing. A user can also adjust search boundaries and the like. Thus, a user can search for a predefined interval of time (e.g., by the half hour, by the hour, by the day, by the week, etc.). Other criteria can also used such as searching by channel and the like and/or sorting by what friends are watching and/or prefer and the like. For example, a user might receive a call from a friend that they've found a great show to watch about Egypt, but the friend can't remember the specific details (e.g., time and/or channel, etc.). The search boundaries can then be limited by that particular friend so that the returned Egypt search results are relevant to Egypt and to that friend.

In another instance, a programming guide is provided with a category filter. When a user types into the search box, a search can be limited within that category and/or time window. In one example, search filter, friend, and/or boundary buttons, etc. can be placed on the programming guide to allow a user to easily limit, associate, and/or filter a search. A user can also set preferences and/or provide predefined tags for programming and the like. Thus, when a search is performed, autocomplete, etc. can sort by a user's tags and then everything else.

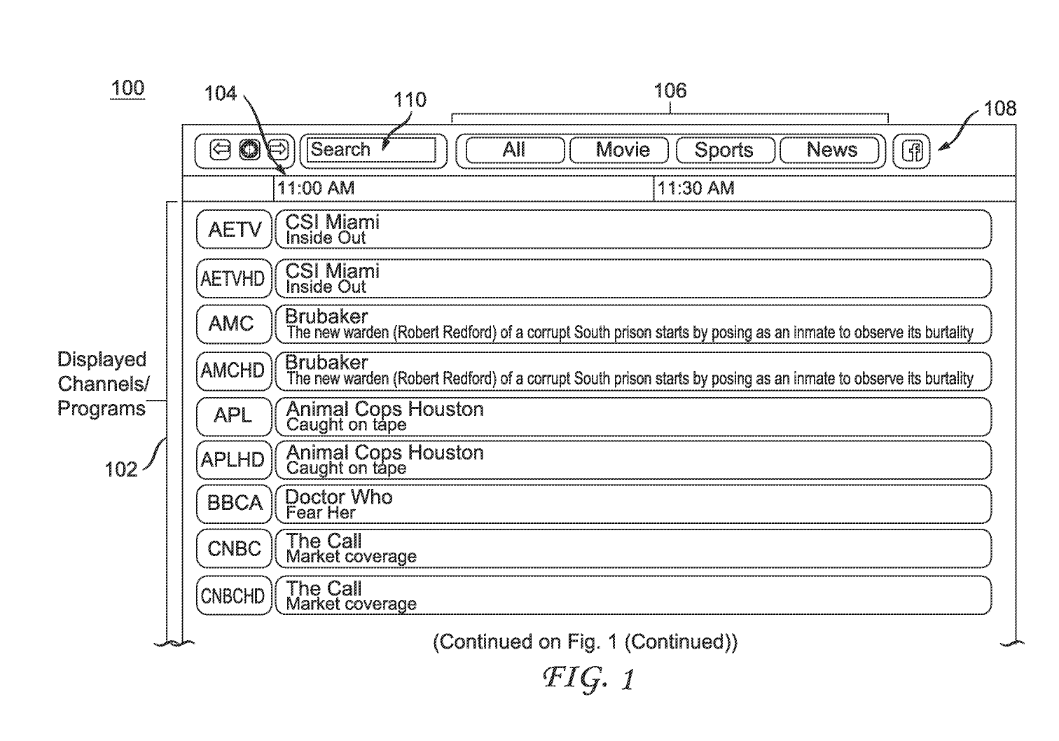

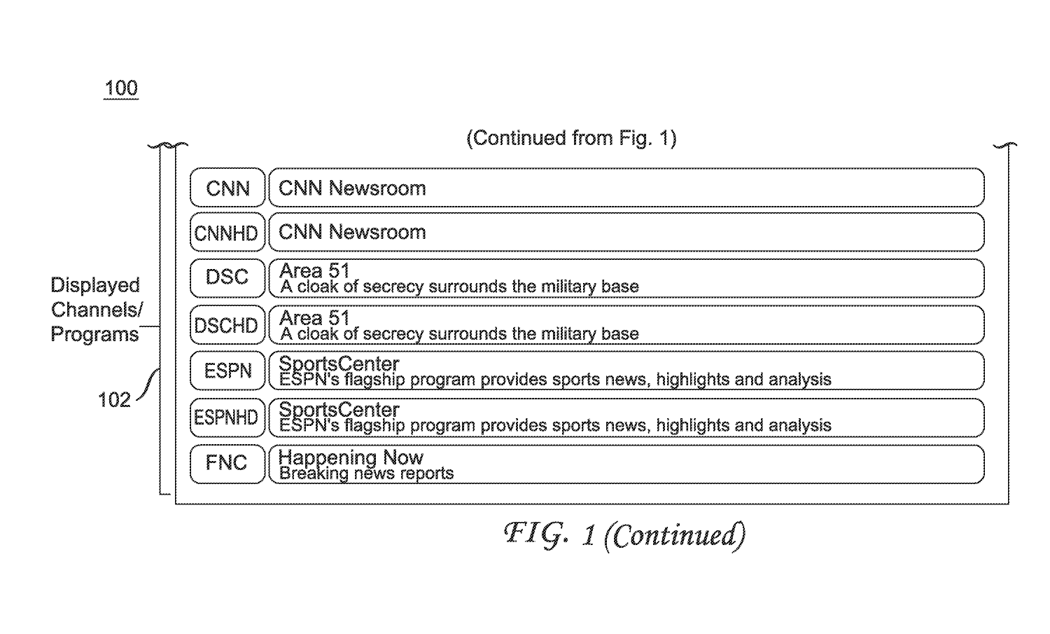

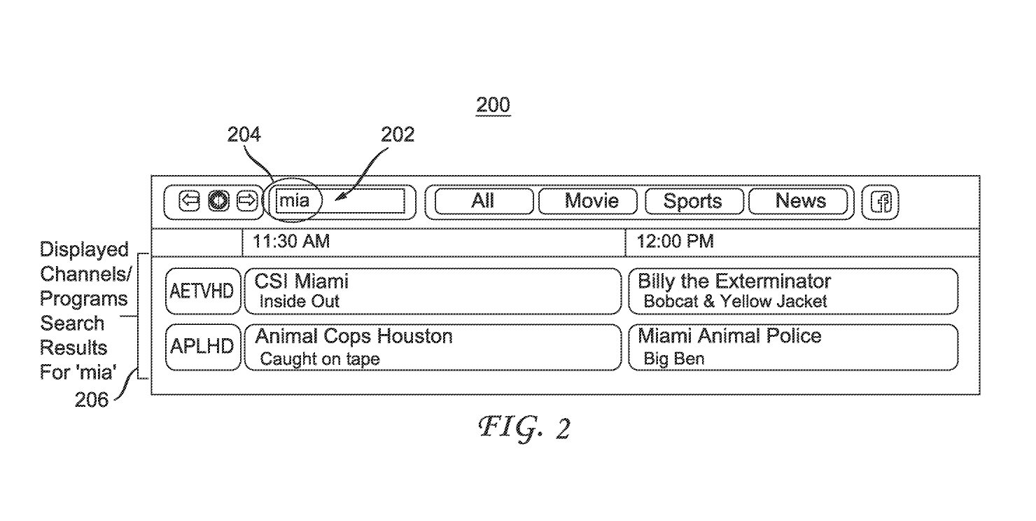

FIGS. 1 and 2 illustrate an example search using the techniques described above. The figures represent what is shown to a user on a display of a screen device. In this instance, the screen device is displaying an electronic program guide. However, other forms of information can be displayed as well.

FIG. 1 shows a screen device display 100 showing an electronic programming guide 102. The guide 102 includes times 104 and channel/program information. Category buttons and/or tabs 106 and a social networking button and/or tab 108 are also shown. The search entry box 110 is blank at this point. If the user so desired, they can select the buttons and/or tabs of the categories and/or social networking/friends and the like to further filter the displayed information before searching.

FIG. 2 depicts the resulting screen device display 200 after “mia” 204 is typed into the search box 202. The electronic program guide information 206 has been reduced from the information 102 shown in FIG. 1 to the display 200 shown in FIG. 2 in real-time. The resulting “mia” search results come from what was displayed in FIG. 1 as the user enters “m” and “i” and “a” (the user sees the results reduced with each keystroke). If the user so desired, they can select the buttons and/or tabs of the categories and/or social networking/friends and the like to further filter the displayed search results.

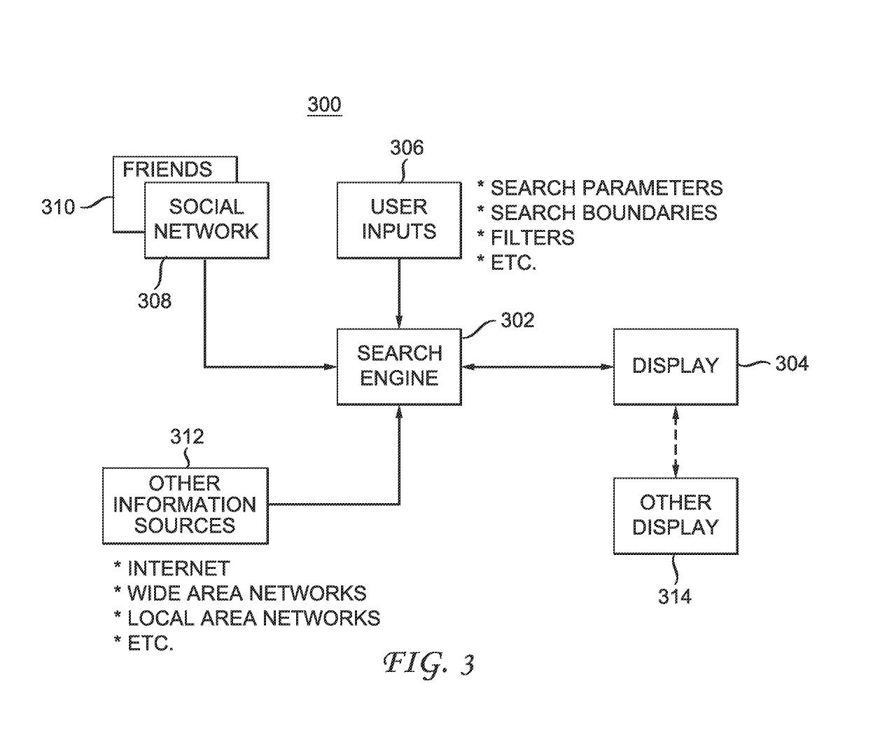

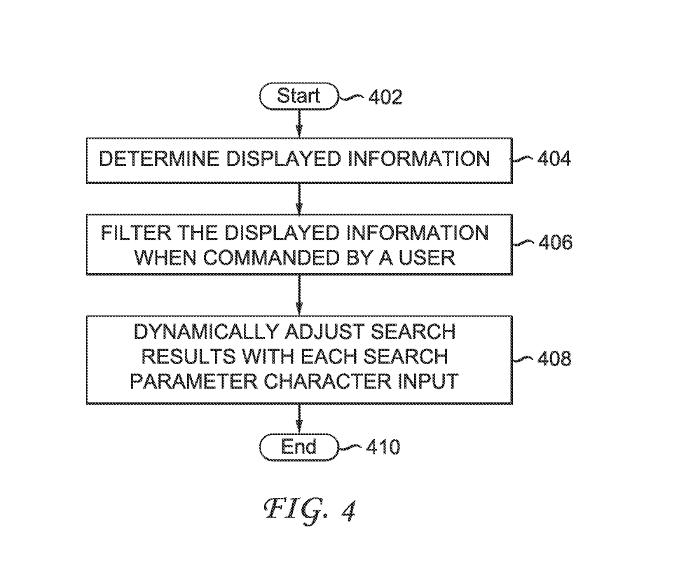

FIG. 3 is an example system 300 that uses a search engine 302 based on information from a display 304. The search engine 302 determines what information is displayed on the display 304 and limits or bounds its search to this information. User inputs 306 can be accepted by the search engine 302 to assist in further bounding the search and/or in filtering the search results and the like. Thus, the user inputs 306 can be, but are not limited to, search parameters/entries, search boundaries information (e.g., by time, by director, based on a particular friend, etc.) and/or filter information (e.g., by time, by director, based on a particular friend, etc.) and the like. The search engine 302 can also utilize information from social networks 308 that can contain information about a user's friends 310 and the like. This helps to limit the search and/or search results to facilitate in providing the most relevant search results. The search engine 302 can also utilize other information sources 312 as well. These other information sources 312 can include, but are not limited to, Internet sources, wide area network (WAN) sources, and/or local area network (LAN) sources and the like. In some instances, the information displayed on the display 304 can be directly associated with another display 314. This information can also be incorporated into the search engine 302 processes as well.

In view of the exemplary systems shown and described above, methodologies that can be implemented in accordance with the embodiments will be better appreciated with reference to the flow chart of FIG. 3. While, for purposes of simplicity of explanation, the methodologies are shown and described as a series of blocks, it is to be understood and appreciated that the embodiments are not limited by the order of the blocks, as some blocks can, in accordance with an embodiment, occur in different orders and/or concurrently with other blocks from that shown and described herein. Moreover, not all illustrated blocks may be required to implement the methodologies in accordance with the embodiments.

FIG. 3 is a flow diagram of a method 300 of determining search results. The method starts 302 by determining what information is displayed 304. The displayed information can be on a laptop, cell phone, pda, pad and/or other handheld and/or stationary device and/or screen. The displayed information can be filtered by a user 306. The filtering criteria can be commanded via voice, selection of a command on a screen and/or other means of inputting user commands. Thus, a user could select to reduce the displayed information by selecting a category, time period and/or social networking based information and the like. As the user inputs characters of their search parameter, the search results are dynamically updated 308, ending the flow 310. This allows the user to input only partial names, etc. for search parameters. The user can guess on correct spelling, etc. and still get relevant search results returned.

What has been described above includes examples of the embodiments. It is, of course, not possible to describe every conceivable combination of components or methodologies for purposes of describing the embodiments, but one of ordinary skill in the art can recognize that many further combinations and permutations of the embodiments are possible. Accordingly, the subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

1. A system that provides search results, comprising:
a device that displays information to a user; and
a search engine that determines what information is currently displayed on the device and limits its search to that information to determine search results for the user.

2. The system of claim 1, wherein the device is one of a mobile phone, a laptop, a pad, a monitor and a television.

3. The system of claim 1, wherein the displayed information is an electronic program guide.

4. The system of claim 1, wherein the search engine dynamically searches the display information as a user inputs search parameter characters.

5. The system of claim 1, wherein the search engine uses at least one user supplied pre-defined boundary when determining what information to search.

6. The system of claim 1, wherein the search engine automatically completes a search entry based on the displayed information.

7. The system of claim 1, wherein the search engine automatically completes a search entry based on social networking information.

8. The system of claim 1, wherein the display information is related to content displayed on another display.

9. A method for determining search results, comprising:
determining what information is displayed on an electronic device; and
bounding a search based on the displayed information.

10. The method of claim 9 further comprising:
dynamically adjusting search results with each search parameter character input.

11. The method of claim 9 further comprising:
automatically completing a search parameter based on at least one of the displayed data, information associated with a social network and another user.

12. The method of claim 9 further comprising:
filtering search results based on user designated filters.

13. The method of claim 9 further comprising:
adjusting the search boundaries based on user input.

14. A system that provides search results, comprising:
a means for determining what information is displayed on an electronic device; and
a means for bounding a search based on the displayed information.

15. The system of claim 14 further comprising:
a means for adjusting the boundary based on at least one of user input, social networking information and time.
